(19) United States
(12) Patent Application Publication
(10) Pub. No.: US 2014/0035823 A1
(43) Pub. Date: Feb. 6, 2014

(54) Dynamic Context-Based Language Determination

(71) Applicant: APPLE INC., Cupertino, CA (US)

(72) Inventors: May-Li Khoe, San Francisco, CA (US); Marcel van Os, San Francisco, CA (US)

(73) Assignee: Apple Inc., Cupertino, CA (US)

(21) Appl. No.: 13/886,959

(22) Filed: May 3, 2013

Related U.S. Application Data
(60) Provisional application No. 61/678,441, filed on Aug. 1, 2012.

(51) Int. Cl. G06F 3/02

(52) U.S. Cl. CPC G06F 3/02
USPC 345/171

(57) ABSTRACT

Methods, systems, computer-readable media, and apparatuses for facilitating message composition are presented. In some embodiments, an electronic computing device can receive user input and determine a set of contextual attributes based on the user input. The device can determine a language based on the set of contextual attributes to determine the language desired to be used for the message composition and switch a keyboard layout to one corresponding to the determined language. Further, the device can determine one or more languages that may be used in the message composition based on the set of contextual attributes and enable functionalities associated with those languages. Further, in some embodiments, the device can determine one or more languages from the user's dictation based on the set of contextual attributes and generate a textual representation of the audio input.

### RELATED APPLICATIONS

This application claims priority to U.S. Provisional Patent Application No. 61/678,441, filed Aug. 1, 2012, which is incorporated by reference herein in its entirety.

### BACKGROUND

Aspects of the present disclosure relate generally to systems and methods for composing a message in an electronic environment, and in particular to composing a message using one or more languages on an electronic device.

There is an increasing number of individuals who can compose messages and/or communicate with different people using different languages and/or more than one language. Various computing systems, including mobile devices, provide functionality that allows users to compose messages using multiple languages. For example, a mobile device may enable a user to type in different languages when the user activates multiple languages (e.g., adds a keyboard language such as an Arabic keyboard or a German keyboard) under the user's keyboard setting. Upon activating the different languages on the user's device, the user can access the activated keyboards in any text field by selecting a particular keyboard or keyboard layout (e.g., via selection of a user selectable item on a user interface displayed on the mobile device). As such, the user may type in two or more languages in the same document as the user selects the user selectable item to indicate a switch between the keyboards.

Conventionally, each computing system is associated with a system language or a default language where the pre-installed applications (e.g., photo applications, e-mail applications) are in the system language. As the user indicates the desire to type by selecting a text field, a keyboard layout corresponding to the default language is displayed. The user may then switch the default keyboard layout to a desired keyboard layout corresponding to the desired language by manually indicating the desired keyboard layout. As mentioned, the user may select a user selectable item (e.g., a globe button) that allows the user to toggle among the activated keyboard layouts on the device until the desired keyboard layout is being displayed. However, it may be undesirable to require the user to manually switch the keyboard layouts as the user shifts from composing a message in one scenario to another.

### SUMMARY

Certain embodiments of the present invention relate to dynamic determination of one or more languages for composing a message in an electronic environment.

A user of an electronic device can compose a message such as an e-mail, a text message, a short messaging service (SMS) message, a note, a memo, etc. by inputting characters via a virtual keyboard displayed on the electronic device. In some embodiments, the electronic device can determine a context surrounding the composition and determine a language most appropriate for the composition (or most likely to be the desired language) based on the context. In response to determining the language, the electronic device can modify the input language to the determined language. In some embodiments, the electronic device can modify the input language by switching a virtual keyboard layout to one that corresponds to the determined language. After the electronic device loads the keyboard layout corresponding to the determined language, the user can compose the message in the desired language. By dynamically determining and loading the desired keyboard language, the electronic device prevents the user from having to identify a keyboard layout currently loaded and then manually altering the keyboard layout to one corresponding to the desired language.

Certain embodiments of the invention relate to dynamic determination of one or more languages for enabling functionality associated with the one or more languages. In some embodiments, functionality associated with a language can include auto-correct functionality, auto-complete functionality, auto-text functionality, grammar-check functionality, spell-check functionality, etc. The electronic device in some embodiments can receive a user input via a keyboard layout corresponding to an initial language. In some embodiments, the electronic device can determine the context based on the user input. For instance, the context can include content of the user input, characteristics of the user and/or the electronic device. The electronic device can determine one or more languages based on the context. For instance, the electronic device can determine that the one or more languages include English and French when the content of the user input refers to San Francisco, French macaroons, and baguette. In another instance, the electronic device can determine that the one or more languages include Spanish and German when the electronic determines that the user is fluent in these two languages. In response to determining the one or more languages, the electronic device can load dictionaries corresponding to the one or more languages in order to activate functionality associated with the language(s). As such, the user may compose the message using the one or more languages while having the functionalities associated with the language(s) enabled at the same time.

Further, certain embodiments of the invention relate to dynamic determination of one or more languages for providing accurate textual representation of an audio input. In some embodiments, an electronic device can receive an audio input from the user and determine the context surrounding the audio input. The context can be determined based on at least one of the user or the electronic device. For example, the context can include languages spoken by the user and accents held by the user. In another example, the context can include a location of the electronic device. In some embodiments, the electronic device can then properly determine one or more languages used in the audio input based on the context surrounding the audio input. Upon identifying the one or more languages used in the audio input, the electronic device can provide the textual representations of the audio input. In some embodiments, in response to identifying the one or more languages, the electronic device can enable functionalities associated with the one or more languages and provide suggestions based on the functionalities, in addition to providing the textual representations.

The following detailed description together with the accompanying drawings will provide a better understanding of the nature and advantages of the present invention.

### BRIEF DESCRIPTION OF THE DRAWINGS

FIG. 1 depicts a simplified block diagram of a system in accordance with some embodiments of the invention.

FIG. 2 illustrates an example of a more detailed diagram of a keyboard language switch subsystem similar to a keyboard language switch subsystem in FIG. 1 according to some embodiments.

FIG. 3 illustrates an example process for loading a keyboard layout corresponding to a desired language according to some embodiments.

FIGS. 4A-4D illustrate an example sequence of screen images for switching the language input mode based on the context in accordance with some embodiments.

FIGS. 5A-5D illustrate another example sequence of screen images for switching the language input mode on an electronic device based on the context according to some embodiments.

FIG. 6 illustrates an example of a more detailed diagram of functionality enabling subsystem similar to a functionality enabling subsystem in FIG. 1 according to some embodiments.

FIG. 7 illustrates an example process for enabling functionality for one or more languages according to some embodiments.

FIGS. 8A-8D illustrate an example sequence of screen images for enabling functionality associated with one or more languages according to some embodiments.

FIG. 9 illustrates an example of a more detailed diagram of dictation subsystem, which is same or similar to the dictation subsystem in FIG. 1, according to some embodiments.

FIG. 10 illustrates an example process for transcribing an audio input including one or more languages according to some embodiments.

FIGS. 11A-11B illustrate an example sequence of screen images for transcribing user input from a message being dictated by a user in accordance with some embodiments.

FIG. 12 is a simplified block diagram of a computer system 100 that may incorporate components of the system in FIG. 1 according to some embodiments.

FIG. 13 illustrates a simplified diagram of a distributed system for implementing various aspects of the invention according to some embodiments.

### DETAILED DESCRIPTION

In the following description, numerous details, examples and embodiments are set forth for the purposes of explanation. However, one of ordinary skill in the art will recognize that the invention is not limited to the embodiments set forth and that the invention may be practiced without some of the specific details discussed. Further, some of the examples and embodiments, including well-known structures and devices, are shown in block diagram form in order not to obscure the description with unnecessary detail.

Certain embodiments of the present invention relate to facilitating message composition in an electronic environment. In some embodiments, an electronic device can facilitate message composition for a user by modifying a keyboard layout corresponding to one language to another keyboard layout corresponding to another language. As the user may desire to use different languages to compose messages in different context, the electronic device can determine a context surrounding the composition and determine a language most appropriate for the composition based on the context. For example, the context can include an intended recipient of the composition and the language can include a language that the user has used in the past to communicate with the intended recipient. In response to determining the language for the occasion, the electronic device can modify the input language to the determined language by loading the keyboard layout corresponding to the determined language and by displaying the loaded keyboard. As such, the user can compose the message in the desired language without having to identify the currently active language and then manually altering the active language to the desired language.

In some embodiments, the electronic device can facilitate message composition by activating various functionalities associated with a language. The electronic device can determine the context surrounding a composition or message and determine one or more languages based on the context. For example, the context can include message content that includes words (e.g., baguette) associated with one or more languages (e.g., English, French). In response to determining the language based on the context, the electronic device can enable functionality associated with the language(s). For instance, the electronic device may enable an auto-correct and/or an auto-complete functionality in both French and English upon identifying that French and English are associated with the composition at hand. As such, the user can compose the message in multiple languages while having various tools (e.g., auto-correct, grammar check, auto-complete, etc.) associated with each language available.

In some embodiments, the electronic device can facilitate message composition by accurately identifying a language and providing textual display from user dictation. The electronic device can receive audio input from a user. In some embodiments, the electronic device can determine the context surrounding the user, the electronic device, and/or the audio input. The electronic device can identify a language based on the context and provide textual representation for the audio input in the identified language. As such, the user can dictate in multiple languages as the electronic device intelligently converts the audio input into textual display.

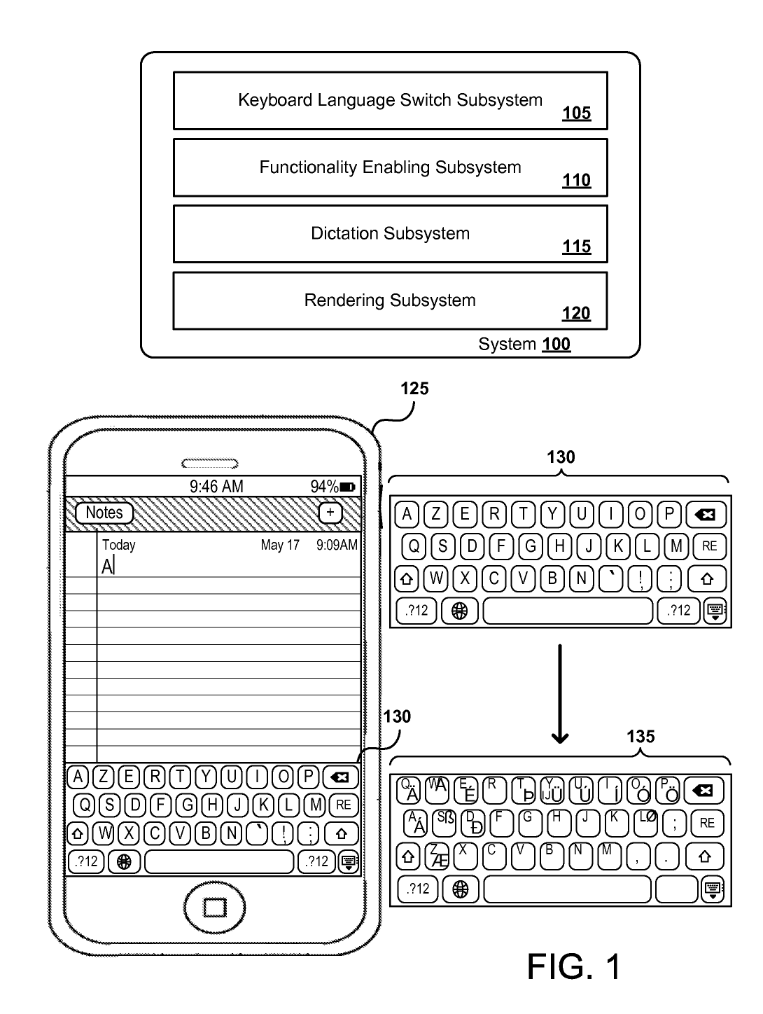

Various embodiments will now be discussed in greater detail with reference to the accompanying figures, beginning with FIG. 1.

FIG. 1 depicts a simplified block diagram of a system 100 for facilitating message composition in accordance with some embodiments. As shown in FIG. 1, system 100 can include multiple subsystems such as a keyboard language switch subsystem 105, a functionality enabling subsystem 110, a dictation subsystem 115, and a rendering subsystem 120. One or more communication paths can be provided to enable one or more of the subsystems to communicate with and exchange data with one another. The various components described in FIG. 1 can be implemented in software, hardware, or a combination thereof In some embodiments, the software can be stored on a transitory or non-transitory computer readable storage medium and can be executed by one or more processing units.

It should be appreciated that system 100 as shown in FIG. 1 can include more or fewer components than those shown in FIG. 1, may combine two or more components, or may have a different configuration or arrangement of components. In some embodiments, system 100 can be a part of an electronic device, such as a computer desktop or a handheld computing device. The various components in system 100 can be implemented as a standalone application or integrated into another application (e.g., an e-mail client, a text messaging application, a word processing application, a browser client, or any other application that involves any type of composition). In some embodiments, the various components in system 100 can be implemented within an operating system.

The various components in system 100 can facilitate composition of a message for a user using an electronic device (such as mobile device 125). In some embodiments, system 100 can dynamically determine one or more languages for the composition and perform one or more operations based on the determined language(s). In one instance, in response to determining a desired language, system 100 modifies the input language from one language to another. As depicted in FIG. 1, system 100 can modify the input language by modifying a keyboard layout 130 that corresponds to a first language to another keyboard layout 135 that corresponds to another language different from the first language.

In some embodiments, keyboard language switch subsystem 105 in system 100 is configured to switch the keyboard layout or load another keyboard layout in response to the language determination. Upon determining a language and loading the keyboard layout corresponding to the language, the electronic device allows the user to compose a message in the determined language without requiring the user to manually switch the keyboard layout. For instance, the user may want to text a spouse in Dutch as they typically communicate using Dutch. Keyboard language switch subsystem 105 may determine from the context (specifically in this case, via prior usage) that the couple typically communicate using Dutch and thereby identify Dutch as the desired language for communication. In response to identifying that Dutch is the desired language, keyboard language switch subsystem 105 can determine whether the currently loaded keyboard language is Dutch and switch the keyboard layout to one corresponding to Dutch if the currently loaded keyboard language is not Dutch, such as that shown in this example. As shown, keyboard layout 130 corresponding to English is switched to one 135 corresponding to Dutch in response to identifying that Dutch is the language in which the user desires to type. As such, the user may then compose the text message using the Dutch keyboard without having to manually modify the keyboard layout.

In some embodiments, functionality enabling subsystem 110 is configured to enable functionality associated with one or more languages in response to the language determination. Functionality enabling subsystem 110 can identify one or more languages pertaining to a message composition based on a set of contextual attributes surrounding the message composition. Upon identifying the language(s), functionality enabling subsystem 110 can activate functionality associated with the language(s). For instance, upon detecting a word (e.g., baguette) that may belong to a different language (e.g., French) compared to the currently active language(s), the electronic device can enable functionality associated with the different language. As such, the electronic device may perform auto-correction, grammar-check, auto-completion, etc. in the different language on the message being composed. In some embodiments, upon determining the one or more languages, the electronic device may load a dictionary associated with the one or more languages in order to enable the functionality associated with the one or more languages.

In some embodiments, dictation subsystem 115 is configured to provide accurate textual representation for an audio input in response to the language determination. Dictation subsystem 115 can determine one or more languages based on a set of contextual attributes. For instance, the language may be determined based on knowledge that the user of the electronic device has a heavy French accent, that the user knows English, French, and German, that the user communicates to a particular recipient in English most of the time, etc. As such, dictation subsystem 110 can identify that the audio input is in English based on the set of contextual attributes surrounding this message composition. Dictation subsystem 110 can generate accurate textual representation based on the audio input in response to determining the language.

In some embodiments, rendering subsystem 120 may enable system 100 to render graphical user interfaces and/or other graphics. For example, rendering subsystem 120 may operate alone or in combination with the other subsystems of system 100 in order to render one or more of the user interfaces displayed by device 125 that is operating system 100. This may include, for instance, communicating with, controlling, and/or otherwise causing device 125 to display and/or update one or more images on a touch-sensitive display screen. For example, rendering subsystem 120 may draw and/or otherwise generate one or more images of a keyboard based on the language determination. In some embodiments, rendering subsystem 120 may periodically poll the other subsystems of system 100 for updated information in order to update the contents of the one or more user interfaces displayed by device 125. In additional and/or alternative embodiments, the various subsystems of system 100 may continually provide updated information to rendering subsystem 120 so as to update the contents of the one or more user interfaces displayed by device 125.

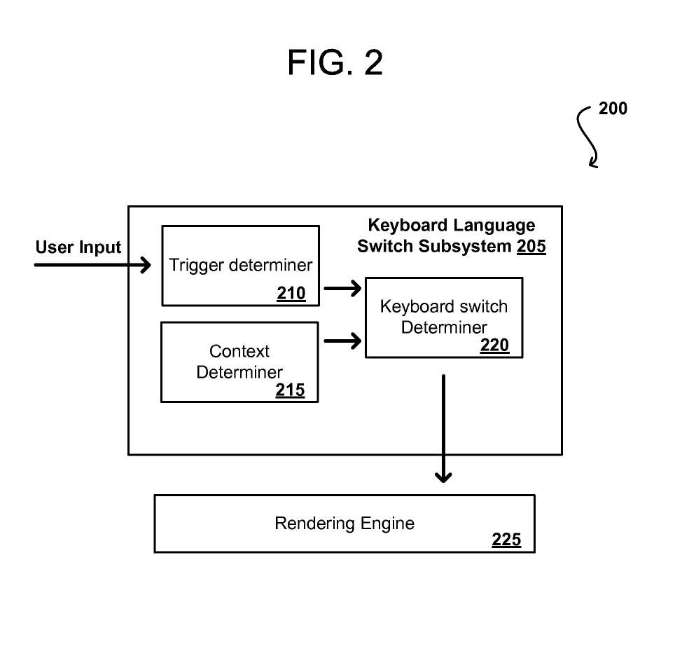

FIG. 2 illustrates an example of a more detailed diagram 200 of a keyboard language switch subsystem 205 similar to keyboard language switch subsystem 105 in FIG. 1 according to some embodiments. In FIG. 2, keyboard language switch subsystem 205 can include a trigger determiner 210, a context determiner 215, and a keyboard switch determiner 220. As mentioned above, in response to determining a set of contextual attributes, keyboard language switch subsystem 205 can determine the appropriate language in which the user would like the message composed. In some embodiments, keyboard language switch subsystem 205 can load the keyboard input language or the keyboard layout corresponding to the determined language and allow the user to compose the message in the desired language.

Trigger determiner 210 in some embodiments can determine when contextual analysis is to be performed. In some embodiments, trigger determiner 210 can detect a trigger or a user action and thereby cause context determiner 215 to determine a set of contextual attributes. For instance, when the user launches an application where the user can compose a message, such as an instant messaging application, a memo drafting application, an e-mail application, etc., trigger determiner 210 can cause context determiner 215 to determine a set of contextual attributes surrounding the composition.

In some embodiments, trigger determiner 210 can cause context determiner 215 to perform the determination when the user indicates to initiate a message composition. For instance, when the user selects a text box that is available for text entry (thereby causing a flashing cursor to be displayed in the text box), trigger determiner 210 can cause context determiner 215 to determine a set of contextual attributes. In another instance, trigger determiner 210 can cause context determiner 215 to perform the determination after the user has performed a textual input (e.g., typed one or more characters), such as after the user has input an e-mail address of a recipient.

Context determiner 215 in some embodiments can determine a set of contextual attributes surrounding the message composition. In some embodiments, context determiner 215 can determine a type of application that the user is using for the message composition, user preferences and history (e.g., including a set of languages frequently used by the user, the user's preferences or past language selections), a number of keyboard languages loaded/active on the electronic device, the different keyboard layouts active on the device, the intended recipient and languages associated with the intended recipient, a location, a time, one or more words being typed that is identifiable in a different language dictionary (and/or frequently typed by the user), etc. The presumption here is that if the user has loaded a particular dictionary and/or language keyboard, that if the intended recipient knows a particular language and prior communication indicates that the user has communicated with the recipient in the particular language, or that if the user is currently in a country that uses the particular language, etc., there is a high likelihood the user may want to compose the message using that particular language. The set of contextual attributes may then be used by keyboard switch determiner 220 to determine the language(s) most likely to be the desired language of use for this composition.

In some embodiments, the set of contextual attributes determined by context determiner 215 may depend on the particular application being used by the user to compose the message. For example, if the user were composing a message in an instant messaging application, context determiner 215 may identify the recipient, languages commonly known between the user and the recipient (e.g., by identifying the languages known by the recipient as specified in the user's address book), and/or identify the language used in prior communication with the recipient. However, if the user were using a lecture note-taking application, context determiner 215 may determine the language previously used in drafting notes under the same category, or determine the audience with whom the user would share the notes and languages understood by the audience.

In some embodiments, keyboard switch determiner 220 can determine one or more languages or candidate languages based on the set of contextual attributes. Keyboard switch determiner 220 in some embodiments can perform a heuristics calculation when determining the language(s) most likely to be the desired language to use in the composition-at-hand. Keyboard switch determiner 220 can use the set of contextual attributes in the calculation and assign a likelihood score to each candidate language. In some embodiments, keyboard switch determiner 220 can automatically select the language with the highest score and perform a keyboard layout switch to one corresponding to the language. Some embodiments provide a warning and allow the user to refuse the switch before performing the switch. In some embodiments, the determined language may include a set of emoticons.

Keyboard switch determiner 220 may also rank the languages from highest score (i.e., most likely to be the desired language) to the lowest score and present the languages as suggestions to the user in the determined order. Keyboard switch determiner 220 can present a set of selectable user interface items representing the suggestions. The user may then select the desired language from the set of selectable user interface items. In some embodiments, keyboard switch determiner 220 may present the languages or keyboard layouts that are ranked as the top three and allow the user to select from those. Keyboard switch determiner 220 in some embodiments may also present the languages or keyboard layouts that have a score beyond a threshold (e.g., 85%) to the user when allowing the user to make the selection. Upon receiving a selection, keyboard switch determiner 220 can cause rendering engine 225 to load the keyboard corresponding to the selected language.

As mentioned, in response to determining the language, keyboard language switch subsystem 205 can cause rendering engine 225 (similar to rendering engine 120) to display a keyboard corresponding to the determined language. In some embodiments, rendering engine 225 can display an animation effect when transitioning the display of the keyboard to another keyboard corresponding to the desired language.

Further, in addition to determining the language that is most likely to be the desired language for the composition, keyboard language switch subsystem 205 may also determine the keyboard layout most likely to be the desired input method. As each language may have multiple ways or types of alphabets that are usable in constructing a word, phrase, or sentence, keyboard language switch subsystem 205 may also determine the likely desirable keyboard layout or input method and load the particular keyboard layout when the corresponding language is selected. In some embodiments, the likely desirable keyboard layout or input method can be determined from the user's prior usage in composing a message in the language.

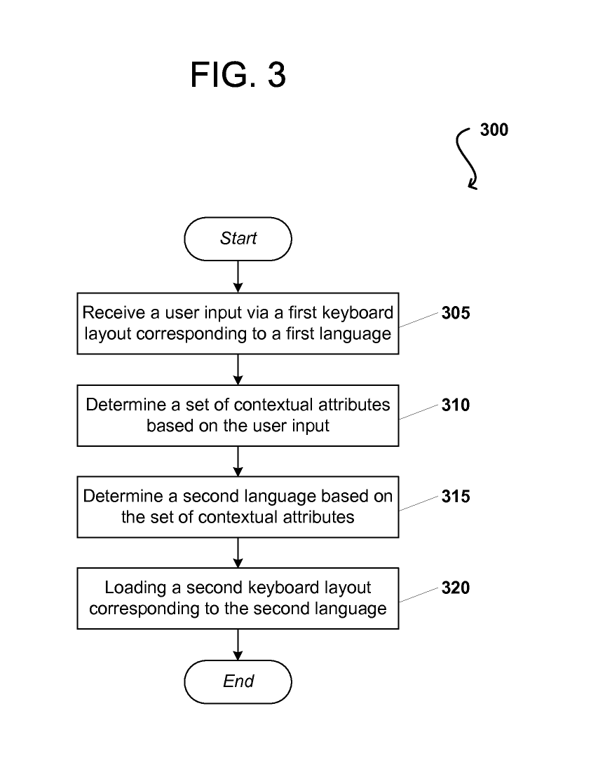

FIG. 3 illustrates an example process 300 for loading a keyboard layout corresponding to a desired language according to some embodiments. As described, a rendering engine (e.g., rendering engine 120 in FIG. 1) may load a keyboard layout different from that currently loaded for display on a user interface of the electronic device when the electronic device determines an appropriate language in which the user would like the message composed. Some or all of the process 300 (or any other processes described herein, or variations and/or combinations thereof) may be performed under the control of one or more computer systems configured with executable instructions and may be implemented as code (e.g., executable instructions, one or more computer programs, or one or more applications) executing collectively on one or more processors, by hardware, or combinations thereof. The code may be stored on a computer-readable storage medium, for example, in the form of a computer program to be executed by processing unit(s), such as a browser application. The computer-readable storage medium may be non-transitory.

At block 305, process 300 can receive a user input via a first keyboard layout corresponding to a first language. In some embodiments, a user of the electronic device may select an application to be launched on the electronic device and indicate to start a message composition using the application, e.g., by selecting a text box in which the user can enter text. The user interface can display a virtual keyboard (the first keyboard layout) that corresponds to the first language (e.g., English) upon receiving the user indication to start a message composition. Through the first keyboard layout, the user can input characters in the corresponding language (the first language).

At block 310, process 300 can determine a set of contextual attributes based upon the user input. As mentioned, the electronic device can determine a set of contextual attributes including a time, a location, active keyboard(s) on the device, the application being used for the message composition, the intended recipient(s) of the message, language(s) spoken by the user and/or the recipient, prior communications between the user and the recipient, the content of the user input, etc. The set of contextual attributes determined by the electronic device for the message composition can be configurable by a user or administrator in some embodiments.

Further, in some embodiments, the contextual attribute may include the frequency a word is typed or used by the user of the electronic device in a particular language. For instance, the user may frequently type the word “ick” which refers to “I” in Dutch, but may be considered gibberish in English. Although the user is typing the word “ick” using an English keyboard, the electronic device may determine that “ick” is a word frequently used by the user and therefore recognize the word as a valid word and determine that the user desires to type in Dutch. In some embodiments, a database that stores the words frequently used by the user across different languages may facilitate message composition upon recognizing that not only is the word valid (i.e., not a misspelled word or nonexistent word), but that the user may desire to compose the rest of the message using a keyboard corresponding to that language or dictionary in which the word is valid.

At block 315, process 300 can determine a second language based upon the set of contextual attributes, where the second language is different from the first language. In some embodiments, a heuristics engine (e.g., included in keyboard switch determiner 220 in FIG. 2) can determine the language that is most likely the one that the user would like to use by assessing the various contextual attributes. The heuristics engine can identify one or more languages and assign each of the one or more languages a likeliness score. In some embodiments, the likeliness score is calculated by the heuristics engine in order to estimate how likely the language is the desired language for the message composition under the current context.

In some embodiments, a particular language can be determined to be the second language when the heuristics engine determines that the second language is highly likely to be the desired language (e.g., if the heuristics engine calculates a likeliness score for a language to be above 90%). The electronic device may allow the user to confirm the switch in some embodiments when the likeliness threshold is determined to be below a threshold (e.g., 50%) and/or present multiple languages as selectable options from which the user can choose the desired keyboard language.

At block 320, process 300 can load a second keyboard layout corresponding to the second language in response to determining the second language. The electronic device can load the second keyboard corresponding to the second language to allow the user to perform character input via the second keyboard. While the electronic device in some embodiments automatically loads the second keyboard upon determining the second language, some embodiments present an option to permit the user to confirm that the switch is indeed desirable.

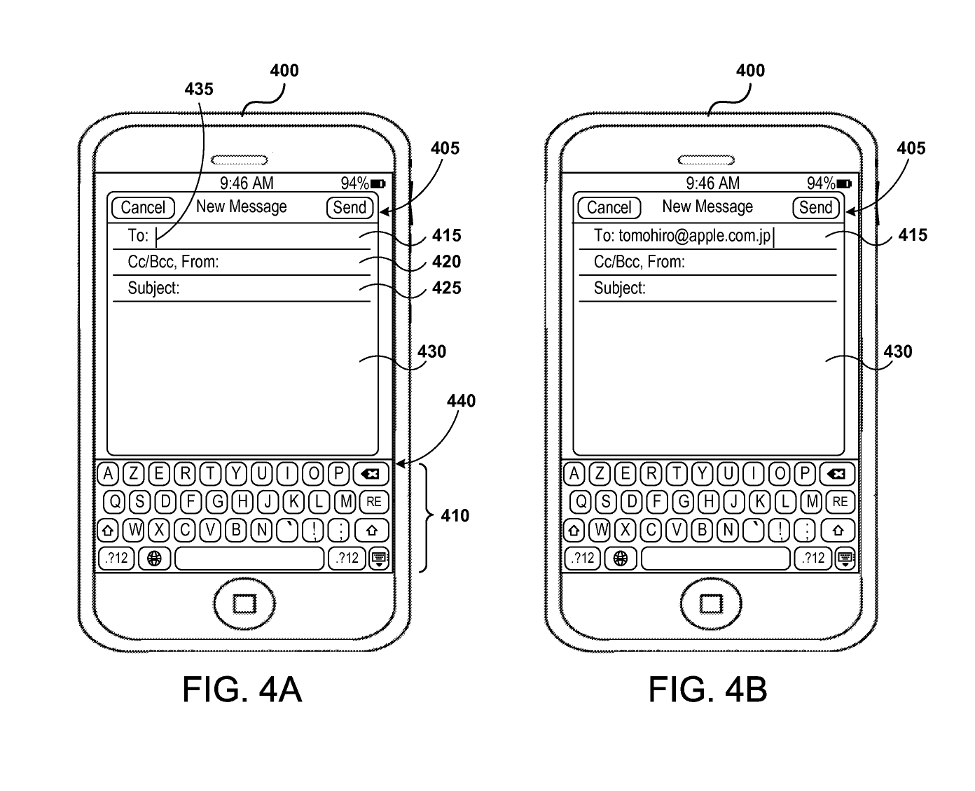

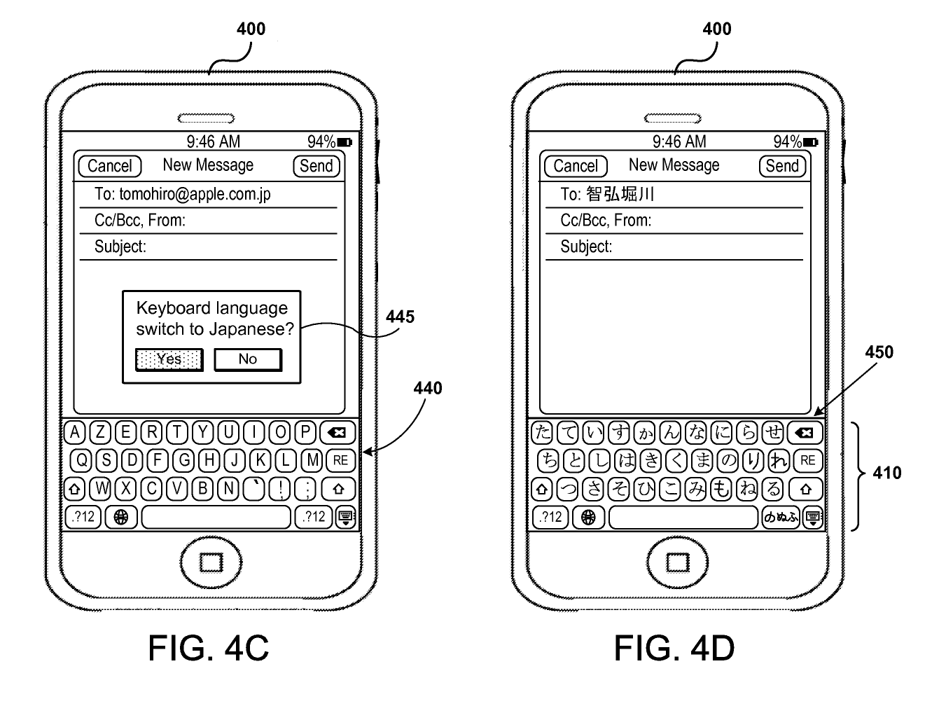

FIGS. 4A-4D illustrate an example sequence of screen images for switching the language input mode on an electronic device based on the context in accordance with some embodiments. As shown in FIG. 4A, an electronic device 400 displays an initial screen that can be associated with a particular application such as an e-mail application on electronic device 400. The initial screen can be displayed on electronic device 400 when the user causes electronic device 400 to launch the application (e.g., by selecting the e-mail application on a virtual desktop).

In some embodiments, the initial screen can include a message composition region 405 and a keyboard layout region 410. Message composition region 405 allows a user to compose an electronic message, such as an e-mail message, to be sent to one or more other users and/or devices. Message composition region 405 may include several fields in which a user may enter text in order to compose the message and/or otherwise define various aspects of the message being composed. For example, message composition region 405 may include a recipients field 415 in which a user may specify one or more recipients and/or devices to receive the message. In addition, message composition region 405 may include a sender field 420 in which a user may specify an account or identity from which the message should be sent (e.g., as the user may have multiple accounts or identities capable of sending messages). Message composition region 405 may further include a subject field 425, in which a user may specify a title for the message, and a body field 430, in which the user may compose the body of the message.

In some embodiments, a keyboard layout 440 may be displayed in a keyboard layout region 410 when the user indicates that the user would like to perform character input. In FIG. 4A, the user has selected an input text field (i.e., recipient field 415) as indicated by the cursor 435, indicating that the user would like to input text. As shown, keyboard layout 440 is displayed in region 410 upon the user indication to input text. In some embodiments, keyboard layout 440 is displayed upon the launching of the application. As shown in this example, the default keyboard language is English and therefore keyboard layout 440 in keyboard layout region 410 corresponds to an English input mode. The default language in some embodiments the can be configured by the user (e.g., via the preferences setting) and/or an administrator.

In FIG. 4B, the user has input an e-mail address of a recipient into recipients field 415. In response to receiving the user input, electronic device 400 can determine a set of contextual attributes surrounding the user input. For instance, the electronic device can identify a recipient corresponding to the e-mail address (e.g., via an address book) and identify a number of languages associated with the recipient (e.g., via the address book, via a social networking website indicating languages associated with the recipient, via a database). In another instance, the electronic device can determine a set of languages used between the user and the recipient in prior communications.

In some embodiments, one or more tags may be associated with the recipient where the tags can identify languages associated with the recipient. The recipient can be tagged with one or more languages based on languages used in prior communications between the user and the recipient and the frequency, etc. The set of contextual attributes used to determine the desired language can include the language tags associated with the recipient. In some embodiments, the tags associated with the recipient may change over time as the electronic device can learn from past behavior. For instance, while the user and the recipient may have communicated using a first language over the first few years, as the user and the recipient increase their communications using a second language, the tag associated with the recipient may change from the first language to the second language.

Further, additional examples of contextual attributes that may be used in the language determination include the identity (e.g., ethnicity, nationality) and the location of the recipient. Some embodiments may perform the language determination upon identifying languages presumably understood by both parties based on the identity of the user and the recipient. Different embodiments may extract different sets of contextual attributes and perform the language determination based on the different set of contextual attributes differently.

In this example, electronic device 400 performs the language determination based on the e-mail of the intended recipient and a number of other contextual attributes. As electronic device 400 has determined that the recipient is Japanese (e.g., based on the username “tomohiro” being a common Japanese name, based on the location of the server being in Japan) and that the user has previously communicated with the recipient using a mixture of Japanese and English, the electronic device may identify Japanese as a candidate language, in addition to English.

In FIG. 4C, the option to switch the keyboard language from English to Japanese is provided in user interface element 445. In this example, the user is given the opportunity to confirm the keyboard layout switch or to deny the keyboard language switch, by selecting one of the two user selectable user interface items in user interface element 445. In some embodiments, upon determining that the language is highly likely (e.g., with a likelihood score of more than 80%) to be the desired language, the electronic device may automatically switch keyboard layout 440 to one corresponding to the determined language (and thereby skip the screen image displayed in FIG. 4C). The electronic device may provide more than one option from which the user can select when multiple languages have been identified as candidate languages.

In FIG. 4D, the screen image in electronic device 400 displays another keyboard layout 450 in keyboard layout region 410 where the other keyboard layout corresponds to the determined language. As shown, in response to receiving user confirmation to perform the keyboard language switch, a keyboard layout 450 corresponding to the Japanese language has been loaded and displayed to the user. Further, in some embodiments, the electronic device may convert any previously typed characters into the determined language. In this example, the previously typed characters including the recipient's e-mail address is now converted to Japanese (e.g., upon direct translation or upon finding the corresponding Japanese name in the user's address book).

Some languages include multiple input methods and therefore have multiple corresponding keyboard layouts. In some embodiments, the electronic device may determine the most common input method that the user has used in the past in typing in the particular language. For instance, the user may have the option to type Chinese using different types of keyboard layouts including a pinyin method, a root-based method, and other types of input methods. The electronic device may select the input method based on the user's usage history and display the corresponding keyboard layout. Different embodiments may perform the determination of the input method for a language differently.

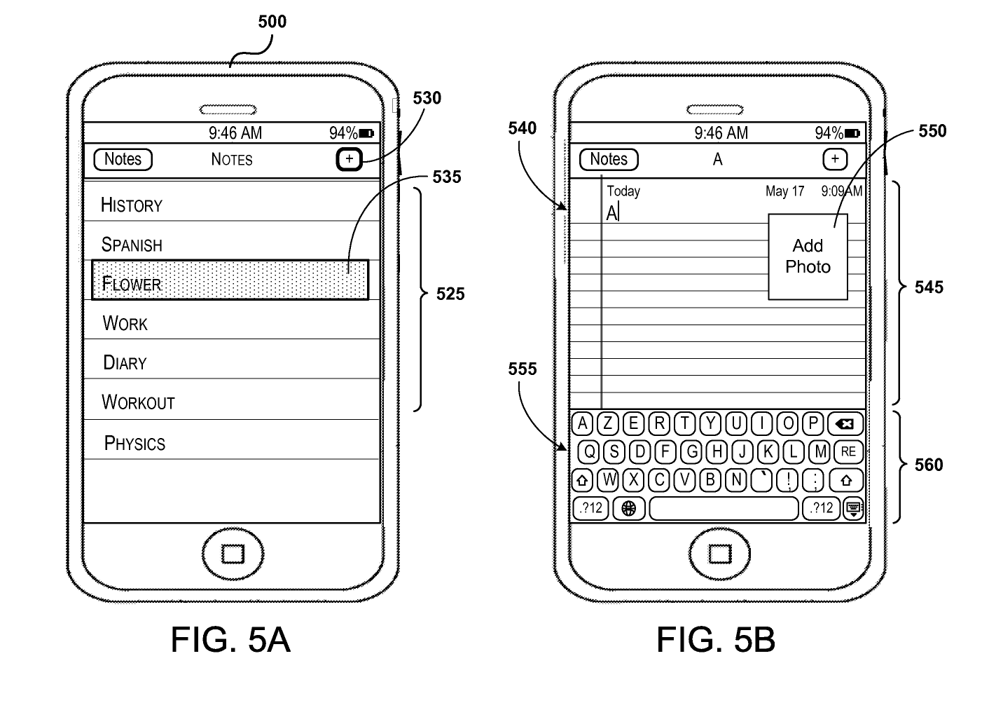

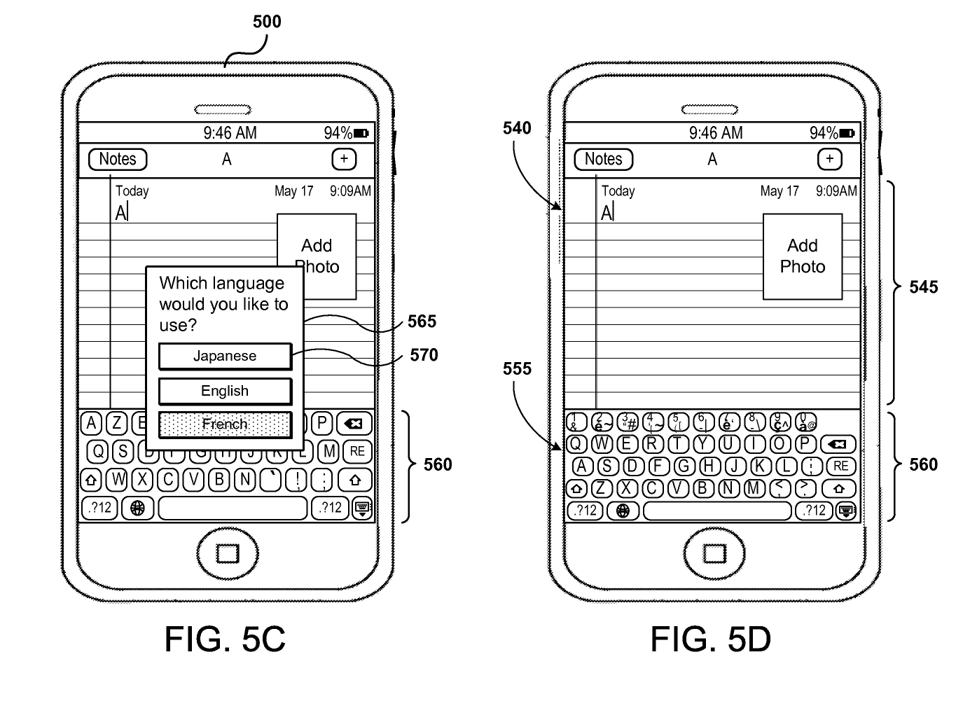

FIGS. 5A-5D illustrate another example sequence of screen images for switching the language input mode on an electronic device based on the context according to some embodiments. As shown in FIG. 5A, a screen image displayed on an electronic device 500 can be associated with another application such as a note-taking or memo composition application. In some embodiments, the screen image can include an initial page upon launching the application, displaying a list of categories 525 under which the user can create new messages.

In this example, the user has created categories including history class, Spanish class, flower arranging class, work-related materials, my diary, workout logs, physics class, etc. The user may create a new memo under one of the categories by identifying one of the categories under which the user would like to compose a message and then selecting selectable user item 530. In this example, the user has indicated that he would like to add a new memo under flower arranging class category 535 by selecting user selectable item 530 after identifying the flower arranging class category 535 (shown as highlighted). Different embodiments may allow the user to add a new memo under a particular category differently.

In FIG. 5B, the screen image displays a memo composition region 540 in which the user may compose electronic notes. Memo composition region 540 may include several fields in which a user may edit. For example, memo composition region 540 may include a body field 545 in which the user may compose the body of the memo and a photo field 550 in which the user may add photos to the memo. When the user indicates the he would like to enter text into body field 545, a virtual keyboard 555 corresponding to a language (e.g., a default language) can be displayed in a keyboard layout region 560. Virtual keyboard 555 may appear using an animation effect such as through a pop up in some embodiments.

In some embodiments, virtual keyboard 555 may correspond to a default language, such as English, while in some embodiments, virtual keyboard 555 may correspond to a language that was last being used by the user (e.g., Spanish) before the user initiated this new memo. In this example, the user was composing a memo in English for his history class memo and therefore an English language keyboard is displayed in keyboard layout region 560. As shown, the user has initiated a composition upon selecting a virtual key within keyboard layout 555

Upon receiving a user indication for composing a message, electronic device 500 can determine a set of contextual attributes surrounding this composition. For example, the electronic device may determine that the previous memos under this category were composed using a mixture of English and Japanese. The electronic device may also determine the ethnicity of the user's classmates in the flower arranging class since the user may typically send class notes to the classmates after class and therefore may desire to compose the memo in a language that can be commonly understood by the classmates. The electronic device may also identify the user's or the device's current location as the user may desire to compose the message in a language that is compatible with the country in which the user is currently residing.

In some embodiments, the different contextual attributes can be assigned different weights when the heuristics engine is determining the set of candidate languages. For instance, in this example, the languages used by memos created under the same category may be given a larger weight compared to the language of the country where the user is currently residing. After weighing the various contextual attributes and their assigned weights, the heuristics engine may more accurately identify the set of candidate languages.

In FIG. 5C, in response to determining the set of candidate languages, electronic device 500 can display the set of candidate languages as selectable options to the user (e.g., in box 565). In some embodiments, the electronic device can display the list including the candidate languages in an order (e.g., by displaying the most likely to be the desired language at the top of the list). In FIG. 5C, electronic device 500 has identified three candidate languages. The candidate languages are displayed to the user to allow the user to select the desired language keyboard to use. As shown in this example, the user has selected a selectable user interface item 570 representing French. In FIG. 5D, a new keyboard layout 555 is loaded and displayed in keyboard layout region 560 where the new keyboard layout 555 corresponds to a French input language. The user may then perform character input in French. As mentioned, some embodiments may further translate the characters and/or words already typed in this new memo in body field 545 into the desired language.

Further, in some embodiments, a user can identify a recipient with multiple names across different languages in an electronic address book accessible by the electronic device. The electronic device in some embodiments may utilize the fact that the recipient is associated with multiple names across multiple languages to identify the language to use when communicating with the recipient. Further, while the user may specify the recipient's name in one language, the electronic device is capable of identifying the recipient regardless of which name and in what language the user uses to identify the recipient.

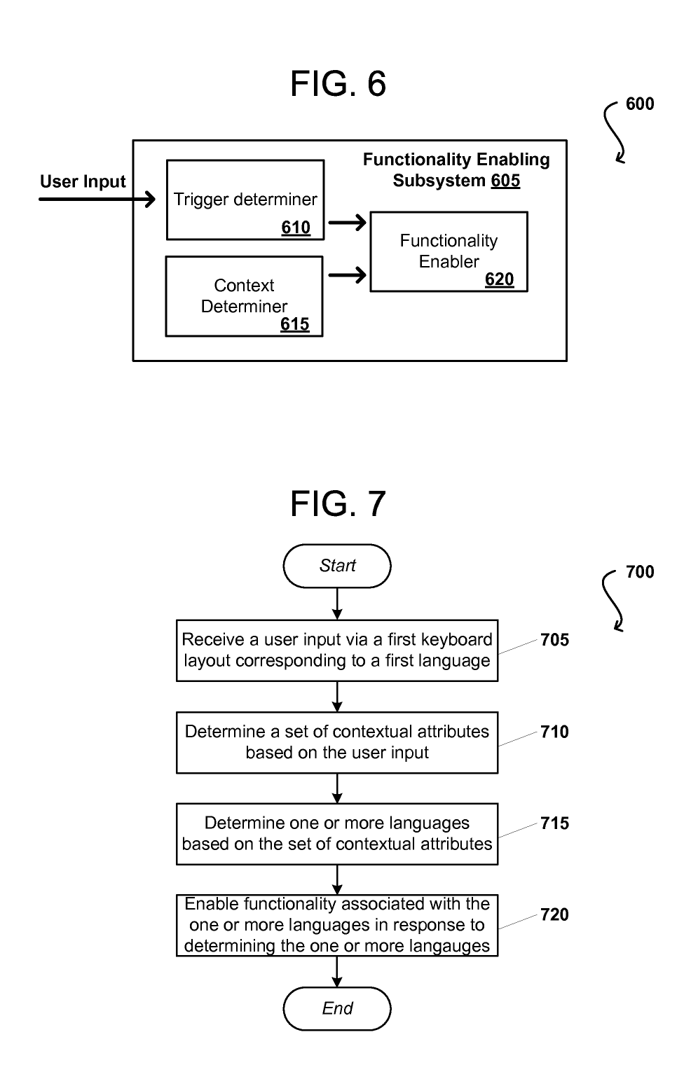

FIG. 6 illustrates an example of a more detailed diagram 600 of functionality enabling subsystem 605 similar to functionality enabling subsystem 110 in FIG. 1 according to some embodiments. In FIG. 6, functionality enabling subsystem 605 can include a trigger determiner 610, a context determiner 615, and a functionality enabler 620. Different embodiments may include more or fewer components than those shown in this example.

Functionality enabling subsystem 605 can identify a set of languages whose associated functionality to enable. Trigger determiner 610 can determine when to identify the set of languages whose associated functionality to enable. In some embodiments, in response to receiving character input (e.g., keyboard input, voice input, touchscreen input), trigger determiner 610 can cause context determiner 615 to determine a set of contextual attributes based on the character input.

In some embodiments, context determiner 615 can determine one or more languages that the user is currently using to compose the message, the language(s) frequently used by the user in composing messages, keyboard language that are currently active on the user's device, languages known by the recipient of the message, content of the message being composed, etc. Functionality enabler 620 may determine a set of languages based on the set of contextual attributes. By calculating a likelihood value for one or more languages using the set of contextual attributes, functionality enabler 6250 can determine the language that would most likely be used in the message composition. Functionality enabler 620 may thereby enable the functionality associated with the language(s).

In some embodiments, upon determining the languages that would most likely be used in the message composition (e.g., by identifying that the content of the user input includes one or more languages), functionality enabler 625 can enable functionality associated with the one or more languages. For instance, if the user types a sentence that includes words and/or phrases belonging to the English and French dictionary, functionality enabler 625 can enable various functionalities (e.g., auto-correct, auto-complete, auto-text, grammar check functionalities) associated with the English and French dictionaries.

In some embodiments, the electronic device can activate functionality associated with more than one dictionary at a time. As such, a user can have enabled functionality associated with the dictionary of multiple languages active, thereby facilitating the composition as the user composes the message in the multiple languages. The electronic device can provide multiple correction suggestions, replacement suggestions, replacements, etc. across multiple languages as the user composes the message.

FIG. 7 illustrates an example process 700 for enabling functionality for one or more languages according to some embodiments. At block 705, process 700 can receive a user input via a keyboard corresponding to a first language. For example, the user may be typing characters in Italian via an Italian keyboard layout.

At block 710, process 700 can determine a set of contextual attributes based on the user input. In some embodiments, the set of contextual attributes can include content of the user input (e.g., the user may refer to items or phrases that may be associated with another language), the location of the user, the intended recipient of a message, etc. In one example, the user may refer to local restaurants, items, etc. in a foreign country where the restaurant name or items would appear to be spelling mistakes in one language but would be correct spellings in the local language.

At block 715, process 700 can determine one or more languages based on the set of contextual attributes. In some embodiments, message composition can be facilitated by enabling functionality associated with one or more languages. Based on the set of contextual attributes, one or more languages can be identified whereby enabling the associated functionality would be useful. For example, upon determining that the user is typing words that belong to more than one language dictionary, some embodiments can determine that the user would likely continue to type words that may belong to those dictionaries. As such, some embodiments may enable functionality associated with those languages to provide useful suggestions associated with the language.

At block 720, process 700 can enable functionality associated with the one or more languages in response to determining the one or more languages. In some embodiments, the functionality associated with the one or more languages may include auto-correct functionalities, auto-complete functionalities, auto-text functionalities, grammar check functionalities, translation, spell check functionalities, thesaurus functionalities, etc. Different embodiments may enable different sets of functionalities for the determined languages. Further, one embodiment may enable a different set of functionalities for each determined language. For instance, while all the functionalities associated with English may be enabled, an electronic device may only enable the spell-check function for Spanish.

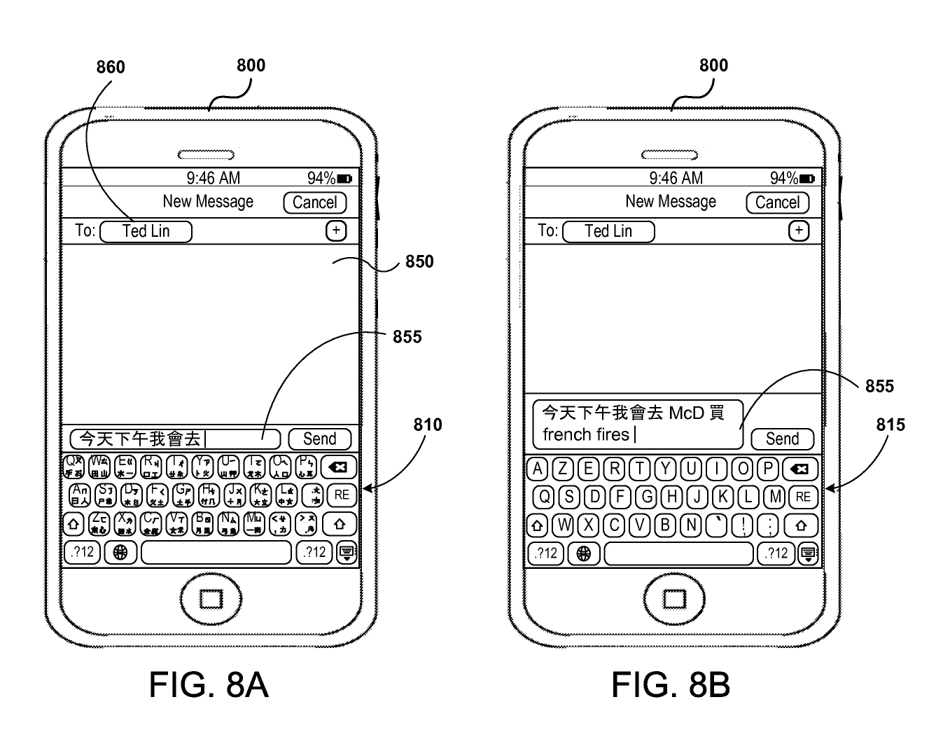

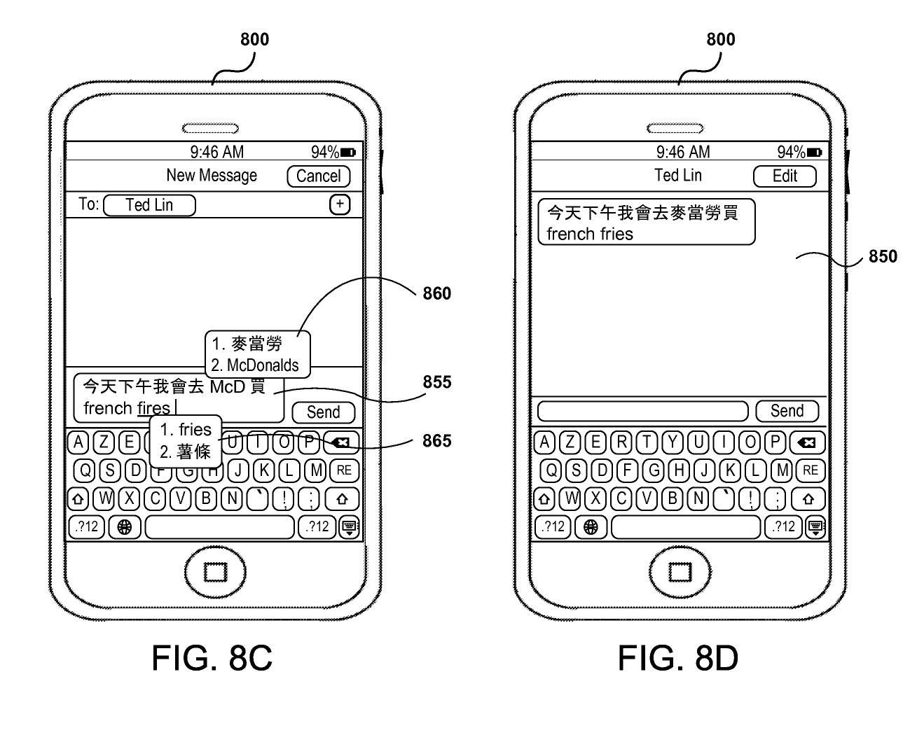

FIGS. 8A-8D illustrate an example sequence of screen images for enabling functionality associated with one or more languages according to some embodiments. As shown in FIG. 8A, an electronic device 800 displays a screen image that can be associated with an application such as an instant messaging application on the electronic device. In this example, the screen image includes a conversation exchange region 850 in which the messages sent and received by the user can be displayed. The screen image also includes a message composition region 855 in which the user can compose a message to be sent to a recipient. Initial screen 805 also includes a recipient field 860 that displays the recipient(s) of the message specified by the user.

In FIG. 8A, the screen image displayed on electronic device 800 shows that the user has input a sentence in message composition region 855. In some embodiments, the electronic device can determine a set of contextual attributes in response to receiving the user input. The set of contextual attributes in this example includes the content of the user input. Specifically, the contextual attributes in this example includes the dictionaries or languages corresponding to the various words and/or phrases in the content. The electronic device may then determine one or more languages based on the contextual attributes. In this example, since the user has input a sentence including words that can be found in the Chinese dictionary and using a Chinese language keyboard 810, electronic device 800 identifies one of the languages to be Chinese.

In some embodiments, electronic device 800 may further confirm Chinese to be one of the languages by analyzing the recipient of the message. Since Ted Lin is the recipient in this example and Ted Lin likely can communicate in Chinese (e.g., according to previous communications, according to the user's address book, according to the name, according to the recipient's nationality), electronic device 800 may assign Chinese a fairly high likelihood score, which indicates how likely a language is to be used in the composition.

Further, in some embodiments, the user may identify each individual in the address book using dual or multiple languages. Since the recipient may be associated with names in different languages, the electronic device may identify the other names that the recipient is associated with and its corresponding language. For example, in Ted Lin may also have a Chinese name, as indicated in the user's address book. As such, electronic device 800 may add further weight to Chinese as being the desired language for communication.

In FIG. 8B, the screen image displayed on electronic device 800 shows that the user has input additional words (e.g., using an English keyboard layout 815) into message composition region 855. The additional words and/or phrases includes another language, English, in this example. As the user inputs additional characters in message composition region 855, electronic device 800 can determine the set of contextual attributes in order to identify any additional language. In this example, electronic device 800 may identify English as an additional language based on the contextual attributes, which includes the content of the sentence and the types of languages used. In some instances, the electronic device may further identify French as an additional language based on the contextual attributes (e.g., a food item that is arguably French-related is mentioned).

In some embodiments, upon determining the one or more languages, the electronic device enables functionality associated with the one or more languages. For example, the electronic device can flag identified errors in the one or more languages and/or provide auto-complete or auto-text suggestions using the dictionaries of the one or more languages. In this example, auto-correct, auto-translate, and spell-check functions are activated for both English and Chinese. As shown in FIG. 8C, electronic device 800 provides auto-translate and auto-correct suggestions for “McD” in box 860 and auto-correct and auto-translate suggestions for “fires” in box 865 as the user types the characters in message composition region 855. In some embodiments, the replacement suggestions may not appear until the user has selected the “send” button.

In some embodiments, electronic device 800 may automatically select the most likely replacement and replace the words/phrases without providing them as suggestions to the user. Here, since functionalities associated with the English and Chinese dictionaries are activated, electronic device 800 can perform various checks using both dictionaries to facilitate message composition. In FIG. 8D, electronic device 800 displays the message sent to the recipient in conversation exchange region 850 after the user has selected the replacements. In some embodiments, the user may select “send” again to indicate that the message is indeed ready to be transmitted. The user may also decide not to select any of the suggestions and select “send” to indicate confirmation of the current message.

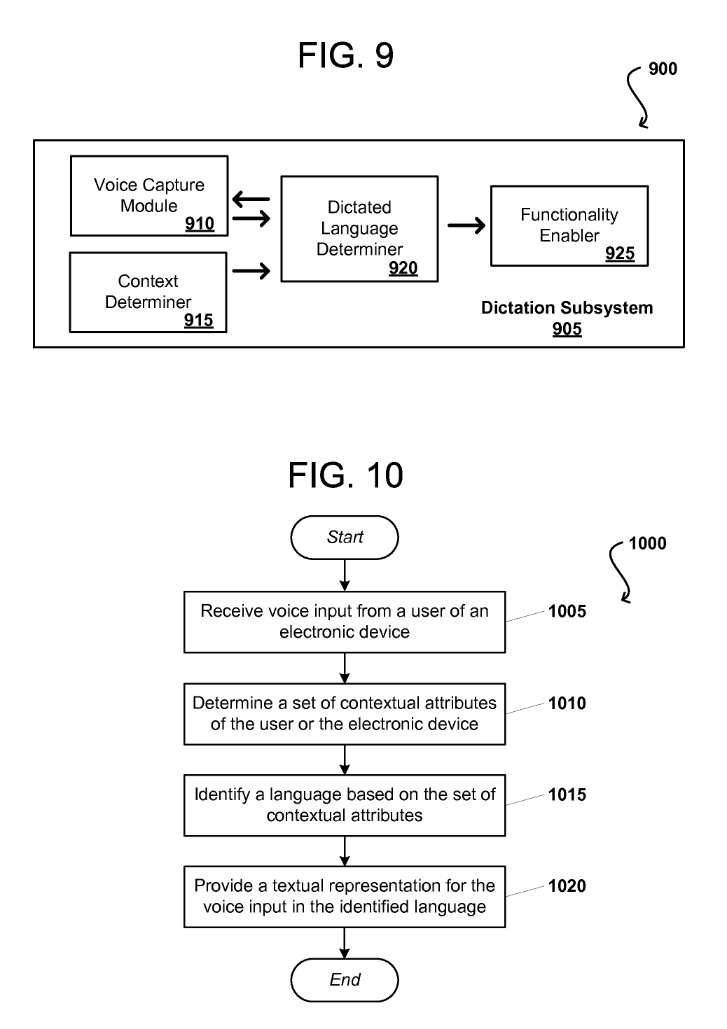

FIG. 9 illustrates an example of a more detailed diagram 900 of dictation subsystem 905, which is same or similar to dictation subsystem 115 in FIG. 1, according to some embodiments. In FIG. 9, dictation subsystem 905 can include a voice capture module 910, a context determiner 915, a dictated language determiner 920, and a functionality enabler 925. As mentioned, different embodiments may include additional or fewer components than those listed in this example.

In some embodiments, voice capture module 910 can capture the user's voice at set intervals. The rate at which voice can be captured may be determined based on the type of language that is being spoken. For example, the rate at which Spanish is captured may be at a faster rate compared to Dutch. As the amount of time people pause in between conversation (i.e., the duration of the gap in between words and/or sentences) generally differs from one language speaker to another, voice capture module 910 can intake voice in designated intervals for different languages. In some embodiments, the capture rate can be set at a default rate corresponding to the default language set to the device. The capture rate can be adjusted in accordance with the type of language being analyzed. While in some embodiments, a voice capture module is used to capture dictated language from the user in set intervals, some embodiments allow the user's voice to be captured and analyzed in real-time.

In some embodiments, context determiner 915 can determine a set of contextual attributes based on at least one of the user or the electronic device of the user. For instance, context determiner 915 can determine a set of languages commonly spoken by the user, one or more languages spoken fluently and natively by the user, accents the user has when speaking other languages, a geographic location or region of the user's origin (e.g., whether the user is from north Netherlands or south Netherlands) and its associated speech characteristics (e.g., further accents, gaps between speech), a current time (as the user's speech characteristics may vary at different times of the day), a current location (as some languages are more frequently used in certain locations than others), a set of keyboard languages active on the electronic device, a system language of the electronic device, the language that the user typically uses (e.g., according to prior usage) to dictate in composing a message under a particular scenario (e.g., when composing a message to a particular recipient, when composing a message under a particular category, when composing a message at a particular time, etc.), etc.

In some embodiments, dictated language determiner 920 can determine one or more languages the user is using while dictating the message. Dictated language determiner 920 can determine the language(s) likely used by the user in composing the dictated message segment captured by voice capture module 910. Based on attributes of the user including languages spoken by the user, accents the user has, etc., dictated language determiner 920 can identify the language(s) likely used by the user. Upon determining the set of languages, dictated language determiner 920 can identify a primary language if there is more than one language identified, and cause voice capture module 910 to adjust the rate at which the voice is captured to correspond to the primary language.

In some embodiments, functionality enabler 925 can enable various functionalities associated with the languages determined by dictated language determiner 920. As such, the electronic device can activate dictionaries associated with the languages and provide suggestive replacements for words or phrases flagged by electronic device (e.g., for spelling errors, auto-text or auto-complete candidates, etc.). Functionality enabler 925 can further provide the suggestive replacements as user interface elements and allow the user to choose whether to replace the words or phrases with the suggested replacement(s). In some embodiments, the suggestive replacements can be across multiple languages, including the languages determined by dictated language determiner 920. In some embodiments, the electronic device may replace the identified errors automatically upon detecting the errors.

Further, in some embodiments, dictation subsystem 905 can include a voice output module that is capable of generating an audio output to the user. The voice output module may correctly pronounce and read the words and/or sentences composed by the user to the user. As the electronic device may pronounce each word and/or phrase accurately based on the dictionaries (e.g., loaded on the device, accessible via a server), the user may find this feature helpful, e.g., when the user cannot look at the screen of the device to determine whether the user's speech has been properly transcribed.

FIG. 10 illustrates an example process 1000 for transcribing an audio input including one or more languages according to some embodiments. In some embodiments, an audio input can be properly transcribed when the one or more languages involved in the audio input are properly identified. At block 1005, process 1000 can receive an audio input from a user of an electronic device. As described, the audio input can include a mixture of one or more languages. In some embodiments, the audio input includes dictated language directed to a content of a message, such as an e-mail message, a text message, a memo, etc. In some instances, the audio input may include a voice command, instructing the electronic device to start a new message for a particular recipient, to translate words and/or phrases (e.g., “translate the first sentence to French, change the third word to German), etc.

At block 1010, process 1000 can determine a set of contextual attributes associated with at least one of the user or the electronic device. In some embodiments, the set of contextual attributes associated with the user can include languages spoken by the user, languages native to the user, characters of the user's speech (e.g., accents of the user in speaking different languages, speed at which the user speaks, intonations, etc.), languages that the user has used to dictate messages in the past, and other attributes relating to the user that may help electronic device identify a language the user is speaking The set of contextual attributes associated with the electronic device can include the location of the device, the keyboard languages active on the device, etc. Further, in some embodiments, the set of contextual attributes can include an intended recipient of the message, languages spoken by the intended recipient, and prior communication between the user and the recipient, etc.

At block 1015, process 1000 can identify a language based on the set of contextual attributes. In some embodiments, a heuristics engine (e.g., included in dictated language determiner 920 in FIG. 9) can determine the languages that are most likely the ones being used by the user in the dictation. The heuristics engine can take the set of contextual attributes into account in determining which languages are being used by the user. For instance, the heuristics engine may properly identify sentences spoken in a language that includes identifiable English words with a heavy French accent and with at a tempo and intonation that is commonly found in French speakers to be English. The heuristics engine may be more certain upon factoring in the fact that the device is currently in the United States or that the user is composing a message to a British client.

At block 1020, process 1000 can provide a textual representation for the audio input in the identified language. In response to identifying the one or more languages used in the dictated message, the electronic device can analyze the audio input and provide the transcription of the audio input. Since the determining of the one or more languages was performed meticulously using the set of contextual attributes, the textual representation may be fairly accurate. The textual representation may include characters across multiple languages.

Further, in some embodiments, as the user composes a message through dictation, the electronic device may enable functionalities associated with the identified language(s). At set intervals or when the user ends a sentence, the electronic device may provide word/phrase replacement suggestions based on the various functionalities enabled. For example, the electronic device may provide auto-translate suggestions, auto-complete suggestions, etc. when the user ends a sentence e.g., identifiable by the user's intonation. The electronic device may provide the suggestions for a set amount of time or for an amount of time that corresponds to the length of the sentence. As such, the user may review the textual representation and select the replacements after the user has completed the sentence or paragraph, etc.

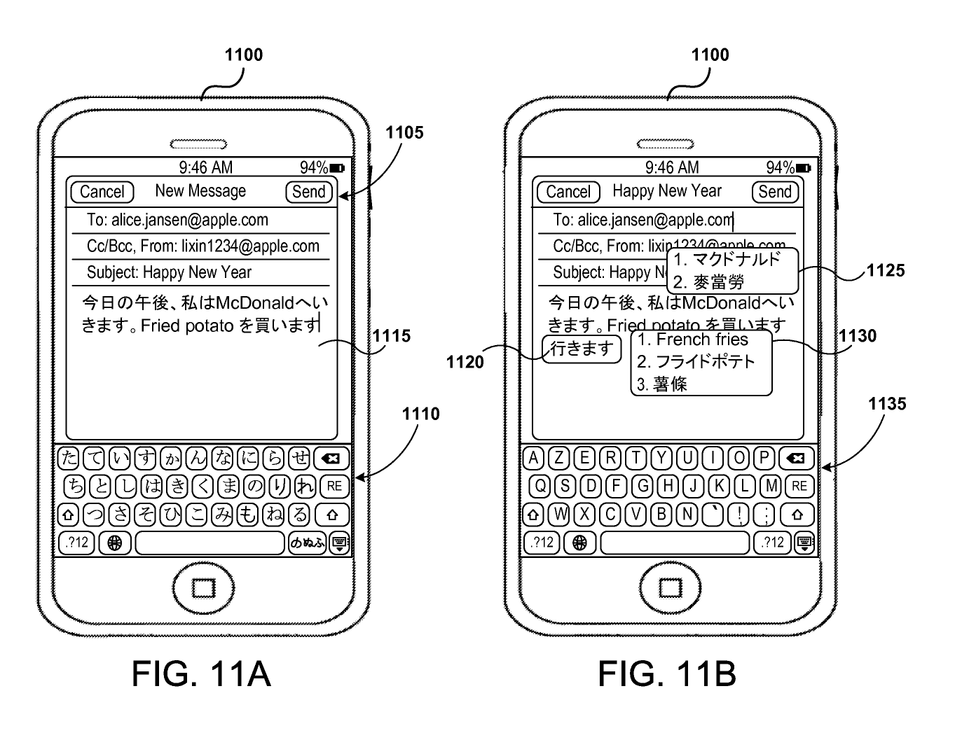

FIGS. 11A-11B illustrate an example sequence of screen images for transcribing user input from a message being dictated by a user in accordance with some embodiments. In FIG. 11A, an electronic device 1100 displays a screen image that is associated with an e-mail application on the electronic device. In some embodiments, screen image can include a message composition region 1105 and a keyboard layout region 1110. Message composition region 1105 allows a user to compose an e-mail message, to be sent to one or more other recipients. Message composition region 1105 may also include several fields in which can specify the recipients of the message, the account from which the message should be sent, and a title of the message. Message composition region 1105 further includes a body field 1115, in which the user may compose the body of the message.

In FIG. 11A, as a message is being dictated by the user, electronic device 1100 displays a transcription of the message in a language determined to be the one likely being used by the user. In this example, the user dictates the message in both Japanese and English. As electronic device 1100 receives the audio input from the user, device 1100 can identify the language(s) being used based on a set of contextual attributes. For instance, the user may have a strong Japanese accent when speaking in English. Therefore, although the intonation and speed at which the user is speaking resembles speech in Japanese, electronic device 1100 recognizes that the user is capable of speaking English, a number of the words/phrases used by the user correspond to the English dictionary, the device is located in the United States of America, English is one of the active keyboard languages on the device, and the recipient is conceivably a white person. As such, electronic device 1100 may identify the language being used by the user to include both English and Japanese, instead of immediately eliminating English as a candidate language due to the intonation or the pronunciation being inaccurate to an extent.

In some embodiments, the electronic device may display a keyboard corresponding to the identified language in response to identifying the language. In the event that more than one language has been identified, the electronic device may display a keyboard layout that corresponds to the language that is the dominantly used language in the message dictation, such that the user may switch to typing in the desired language instead of dictating the message. For instance, when a user dictates a message using mainly Dutch but with some English words interspersed in the sentences, the electronic device may display or switch to a keyboard that corresponds to Dutch instead of English. As shown in this example, electronic device 1100 can determine that Japanese is the primary language being used in dictation this message. Therefore, electronic device 1100 may display a keyboard layout 1110 corresponding to Japanese, although both English and Japanese have been identified as candidate languages in this instance.

In FIG. 11B, after determining the one or more languages being used by the user, electronic device 1100 may activate one or more functionalities associated with the identified languages. In this example, an auto-translate function has been activated for Japanese and English in response to the languages being determined. As shown, a suggestion 1120 to correct the phrase expression and suggestions 1125 and 1130 for translation of terms are provided to the user in which the user can either accept or reject. While in some embodiments, electronic device 1100 may present these suggestions upon identifying the end of a sentence, some embodiments present the suggestions in real-time as the user is dictating the message. In some embodiments, the suggestions are presented for a predetermined time period after they appear or after the user finishes the dictation. This allows the user to have sufficient time to review the transcribed sentences along with the suggestions and select the desirable suggestions.

Further, some embodiments allow the user to switch the keyboard temporarily to the secondary language (in this example, English) in response to user selection of a user selectable item (not shown) on the user interface or upon toggling a button on the device. The keyboard may then switch back to corresponding to the primary language when the user releases the user selectable item or reverses the toggled button. As shown in FIG. 11B, keyboard layout 1110 has been modified to another keyboard layout 1135 corresponding to English. This may be performed in response to receiving a user indication to temporarily switch the keyboard language to the other active language (or to one of the other identified languages).

Further, when electronic device 1100 determines the suggestions, electronic device 1100 may also consider the cultural background of the speaker and provide suggestions that might be the equivalent in the language the speak is trying to compose the message. For instance, although in Japan, the direct translation or pronunciation of French fries from Japanese to English would be fried potato, the electronic device may recognize such usage as being uncommon in the United States and thereby provide a suggestion to correct the word. The electronic device in some embodiments may also offer to translate words and/or sentences into a different language when the device has determined (e.g., via a database) that the different language is one used very frequently by the user and/or the recipient.

In some embodiments, the electronic device may recognize oral commands from the user. The user may instruct the electronic device to read the transcribed words and/or sentences back to the user, such that the user may identify whether the words and/or sentences were properly transcribed. Additionally, the electronic device may receive commands for translation of words and/or sentences within the composed message to a different language.

Many of the above-described features and applications can be implemented as software processes that are specified as a set of program instructions encoded on a computer readable storage medium. When these program instructions are executed by one or more processing units, the program instructions cause the processing unit(s) to perform the actions indicated in the instructions. Examples of computer readable storage media include CD-ROMs, flash drives, RAM chips, hard drives, EPROMs, etc. The computer readable storage media does not include carrier waves and electronic signals passing wirelessly or over wired connections. “Software” refers generally to sequences of instructions that, when executed by processing unit(s) cause one or more computer systems to perform various operations, thus defining one or more specific machine implementations that execute and perform the operations of the software programs.

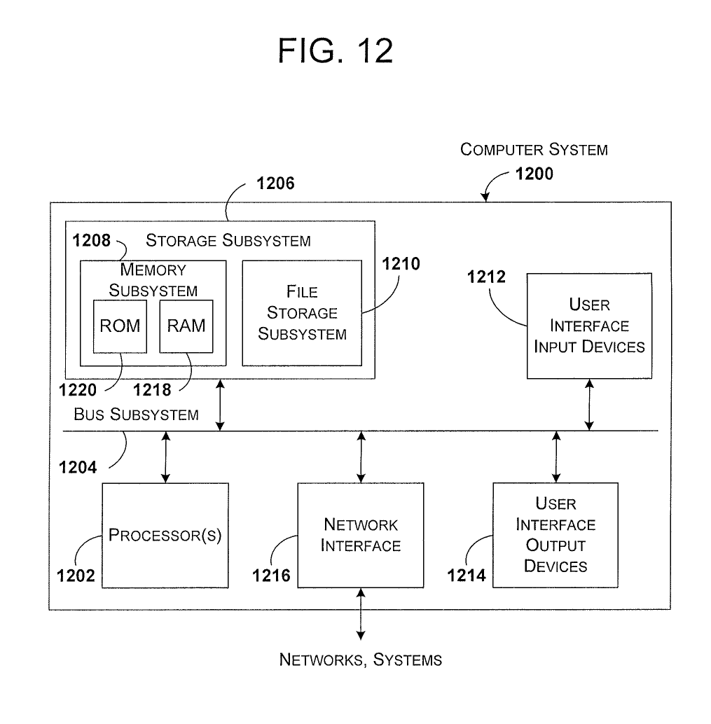

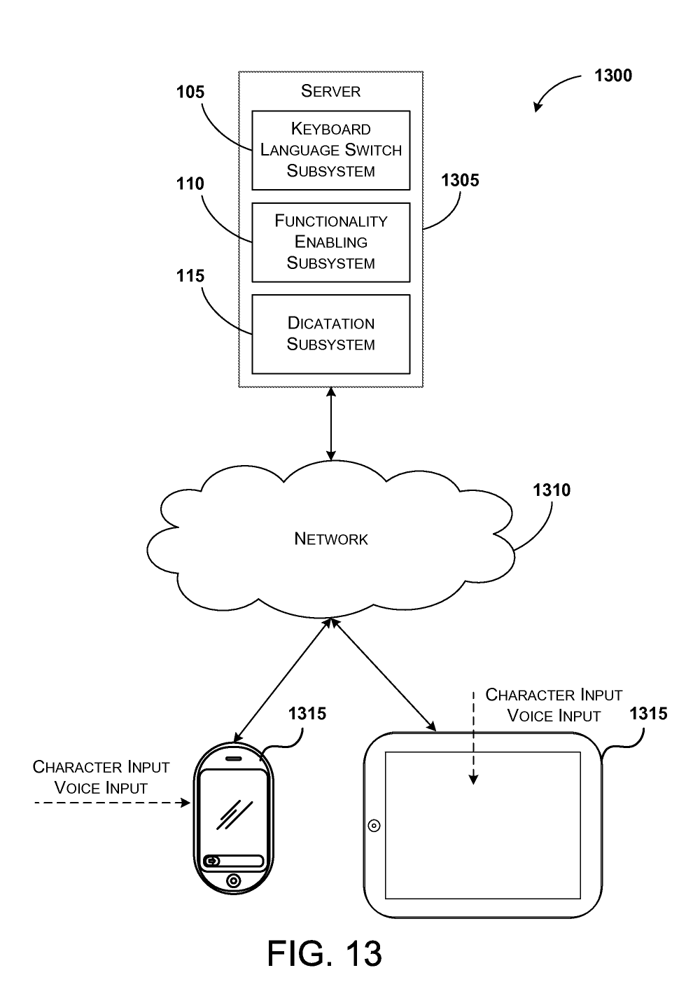

System 100 depicted in FIG. 1 may be incorporated into various systems and devices. FIG. 12 is a simplified block diagram of a computer system 1200 that may incorporate components of system 100 according to some embodiments. Computer system 1200 can be implemented as any of various computing devices, including, e.g., a desktop or laptop computer, tablet computer, smart phone, personal data assistant (PDA), or any other type of computing device, not limited to any particular form factor. As shown in FIG. 12, computer system 1200 can include one or more processing units 1202 that communicates with a number of peripheral subsystems via a bus subsystem 1204. These peripheral subsystems may include a storage subsystem 1206, including a memory subsystem 1208 and a file storage subsystem 1210, user interface input devices 1212, user interface output devices 1214, and a network interface subsystem 1216.

Bus subsystem 1204 can include various system, peripheral, and chipset buses that communicatively connect the numerous internal devices of electronic device 1200. For example, bus 1204 can communicatively couple processing unit(s) 1805 with storage subsystem 1810. Bus 1840 also connects to input devices 1202 and a display in user interface output devices 1214. Bus subsystem 1204 also couples electronic device 1200 to a network through network interface 1216. In this manner, electronic device 1200 can be a part of a network of multiple computer systems (e.g., a local area network (LAN), a wide area network (WAN), an Intranet, or a network of networks, such as the Internet. Any or all components of electronic device 1200 can be used in conjunction with the invention.

Processing unit(s) 1202, which can be implemented as one or more integrated circuits (e.g., a conventional microprocessor or microcontroller), can control the operation of computer system 1200. In some embodiments, processing unit(s) 1202 can include a general-purpose primary processor as well as one or more special-purpose co-processors such as graphics processors, digital signal processors, or the like. In some embodiments, some or all processing units 1202 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 1202 can execute instructions stored in storage subsystem 1206. In various embodiments, processor 1202 can execute a variety of programs in response to program code and can maintain multiple concurrently executing programs or processes. At any given time, some or all of the program code to be executed can be resident in processor 1202 and/or in storage subsystem 1206. Through suitable programming, processor 1202 can provide various functionalities described above for performing context and language determination and analysis.

Network interface subsystem 1216 provides an interface to other computer systems and networks. Network interface subsystem 1216 serves as an interface for receiving data from and transmitting data to other systems from computer system 1200. For example, network interface subsystem 1216 may enable computer system 1200 to connect to a client device via the Internet. In some embodiments network interface 1216 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments network interface 1216 can provide wired network connectivity (e.g., Ethernet) in addition to or instead of a wireless interface.

User interface input devices 1212 may include a keyboard, pointing devices such as a mouse or trackball, a touchpad or touch screen incorporated into a display, a scroll wheel, a click wheel, a dial, a button, a switch, a keypad, audio input devices such as voice recognition systems, microphones, and other types of input devices. In general, use of the term “input device” is intended to include all possible types of devices and mechanisms for inputting information to computer system 1200. For example, in a smartphone, user input devices 1212 may include one or more buttons provided by the smartphone, a touch screen, and the like. A user may provide input regarding selection of which language to use for translation or keyboard language switching using one or more of input devices 1212. A user may also input various text or characters using one or more of input devices 1212.

User interface output devices 1214 may include a display subsystem, indicator lights, or non-visual displays such as audio output devices, etc. The display subsystem may be a cathode ray tube (CRT), a flat-panel device such as a liquid crystal display (LCD), a projection device, a touch screen, and the like. In general, use of the term “output device” is intended to include all possible types of devices and mechanisms for outputting information from computer system 1200. For example, menus and other options for selecting languages or replacement suggestions in composing a message may be displayed to the user via an output device. Further, the speech may be output via an audio output device.

In some embodiments, the display subsystem can provide a graphical user interface, in which visible image elements in certain areas of the display subsystem are defined as active elements or control elements that the user selects using user interface input devices 1212. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in the display subsystem. Other user interfaces can also be implemented.

Storage subsystem 1206 provides a computer-readable storage medium for storing the basic programming and data constructs that provide the functionality of some embodiments. Storage subsystem 1206 can be implemented, e.g., using disk, flash memory, or any other storage media in any combination, and can include volatile and/or non-volatile storage as desired. Software (programs, code modules, instructions) that when executed by a processor provide the functionality described above may be stored in storage subsystem 1206. These software modules or instructions may be executed by processor(s) 1202. Storage subsystem 1206 may also provide a repository for storing data used in accordance with the present invention. Storage subsystem 1206 may include memory subsystem 1208 and file/disk storage subsystem 1210.

Memory subsystem 1208 may include a number of memories including a main random access memory (RAM) 1218 for storage of instructions and data during program execution and a read only memory (ROM) 1220 in which fixed instructions are stored. File storage subsystem 1210 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 1200 can be of various types including a personal computer, a portable device (e.g., an iPhone®, an iPad®), a workstation, a network computer, a mainframe, a kiosk, a server or any other data processing system. Due to the ever-changing nature of computers and networks, the description of computer system 1200 depicted in FIG. 12 is intended only as a specific example. Many other configurations having more or fewer components than the system depicted in FIG. 12 are possible.

Various embodiments described above can be realized using any combination of dedicated components and/or programmable processors and/or other programmable devices. The various embodiments may be implemented only in hardware, or only in software, or using combinations thereof. The various processes described herein can be implemented on the same processor or different processors in any combination. Accordingly, where components are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

FIG. 13 illustrates a simplified diagram of a distributed system 1300 for implementing various aspects of the invention according to some embodiments. In the embodiment illustrated in FIG. 13, keyboard language switch subsystem 105, functionality enabling subsystem 110, and dictation subsystem 115 are provided on a server 1005 that is communicatively coupled with a remote client device 1315 via network 1310.

Network 1310 may include one or more communication networks, which can be the Internet, a local area network (LAN), a wide area network (WAN), a wireless or wired network, an Intranet, a private network, a public network, a switched network, or any other suitable communication network. Network 1310 may include many interconnected systems and communication links, including, but not limited to, hardware links, optical links, satellite or other wireless communication links, wave propagation links, or any other ways for communication of information. Various communication protocols may be used to facilitate communication of information via network 1310, including, but not limited to, TCP/IP, HTTP protocols, extensible markup language (XML), wireless application protocol (WAP), protocols under development by industry standard organizations, vendor-specific protocols, customized protocols, and others.

In the configuration illustrated in FIG. 13, a user of client device 1315 may perform a user input, either via touching a touchscreen displaying a keyboard layout or via voice. Upon receiving the user input, device 1315 may communicate with server 1305 via network 1010 for processing. Keyboard language switch subsystem 105, functionality enabling subsystem 110, and dictation subsystem 115 located on server 1305 then may cause a keyboard layout to be provided on device 1315, cause functionalities associated with various languages to be enabled, or cause the user interface on device 1315 to display textual representation of the user input. Additionally or alternatively, these subsystems may cause various replacement suggestions to be provided and/or may cause the keyboard layout to switch or cause the suggestions to replace the original textual representation, as in the examples discussed above.

Various different distributed system configurations are possible, which may be different from distributed system 1300 depicted in FIG. 13. For example, in some embodiments, the various subsystems may all be located remotely from each other. The embodiment illustrated in FIG. 13 is thus only one example of a system that may incorporate some embodiments and is not intended to be limiting.

Thus, although the invention has been described with respect to specific embodiments, it will be appreciated that the invention is intended to cover all modifications and equivalents within the scope of the following claims. For example, the list of criteria or contextual attributes identified above is not meant to be exhaustive or limiting. In some other embodiments, more or less than the criteria described above may be used. Further, the manner in which the various criteria are used may also vary between embodiments. For example, in one embodiment, each criterion may be used independent of the other criteria to identify zero or more possible language candidates for keyboard language switching or functionality enabling, etc. In such an embodiment, a set of zero or more language candidates may be identified from analysis performed for each criterion. In another embodiment, two or more criteria may be combined to identify the candidate languages. The criteria-based processing may be performed in parallel, in a serialized manner, or a combination thereof

The various embodiments are not restricted to operation within certain specific data processing environments, but are free to operate within a plurality of data processing environments. Various modifications and equivalents are within the scope of the following claims.

What is claimed is:

1. A method comprising:
receiving, by an electronic device, user input via a first keyboard corresponding to a first language;
determining, by the electronic device, a set of contextual attributes based upon the user input;
determining, by the electronic device, a second language based upon the set of contextual attributes, wherein the second language is different from the first language; and
in response to determining the second language, loading a second keyboard corresponding to the second language.

2. The method of claim 1, wherein the user input comprises at least one of initiating a communication with a recipient or initiating a composition in an application.

3. The method of claim 1, wherein the set of contextual attributes is determined in response to receiving the user input via the first keyboard corresponding to the first language.

4. The method of claim 1, wherein the set of contextual attributes includes at least one of a time at which the user input is received, a location of the electronic device, a recipient identified in the user input, content of the user input, prior usages in language by a user of the electronic device, or keyboards currently loaded on the electronic device corresponding to different languages.

5. The method of claim 1 further comprising:
enabling functionality associated with a dictionary of the second language in response to determining the second language, wherein the functionality includes at least one of an auto-correct functionality or an auto-complete functionality.

6. A computer readable storage medium encoded with program instructions that, when executed, cause a processor in an electronic device to execute a method, the method comprising:
receiving user input via a first keyboard corresponding to a first language;
determining a set of contextual attributes based upon the user input;
determining a second language based upon the set of contextual attributes, wherein the second language is different from the first language; and
in response to determining the second language, loading a second keyboard corresponding to the second language.

7. The computer readable storage medium of claim 6 further comprising:
receiving a specification of an intended recipient for a message, wherein the set of contextual attributes includes a particular language frequently used between a user of the electronic device and the intended recipient, wherein the second language is determined to be the particular language.

8. The computer readable storage medium of claim 6 further comprising:
receiving an indication to activate an e-mail application, wherein the received user input includes a specification of an e-mail address of an intended recipient of an e-mail message.

9. The computer readable storage medium of claim 6 further comprising:
receiving an indication to activate a memo application, wherein the received user input includes identification of a category for a note for which the note is composed, wherein the set of contextual attributes includes the category and the second language includes a language in which most notes in the category are composed.

10. The computer readable storage medium of claim 6, wherein loading the second keyboard includes animating a transition of a virtual keyboard display from being of the first language to being of the second language.

11. An electronic device comprising:
a processor; and
a display in communication with the processor, wherein the processor is configured to:
receive user input via a first keyboard corresponding to a first language;
determine a set of contextual attributes based upon the user input;
determine a second language based upon the set of contextual attributes, wherein the second language is different from the first language; and
in response to determining the second language, loading a second keyboard corresponding to the second language.

12. The electronic device of claim 11, wherein the processor is further configured to:
convert the received user input in the first language to the second language in response to determining the second language.

13. The electronic device of claim 11, wherein the processor is further configured to:
reload the first keyboard corresponding to the first language in response to receiving a user indication.

14. The electronic device of claim 11, wherein the user input includes a specification of a plurality of recipients, wherein the set of contextual attributes includes languages spoken by each of the plurality of recipients, and wherein determining the second language includes determining a particular language commonly spoken by each of the plurality of recipients.

15. The electronic device of claim 11, wherein the user input identifies an intended recipient, wherein the set of contextual attributes includes languages used to communicate between a user of the electronic device and the intended recipient in their communication history, and wherein determining the second language is based upon the most frequently used language between the user and the intended recipient.
